(19) United States
(12) Patent Application Publication
(10) Pub. No.: US 2026/0202627 A1
(43) Pub. Date: Jul. 16, 2026

(54) TECHNIQUES FOR REDUCING POWER OF AN OPTICAL PULSE RECEIVED BY A SUPERCONTINUUM GENERATOR

(71) Applicant: Honeywell International Inc., Charlotte, NC (US)

(72) Inventors: Matthew Wade Puckett, Phoenix, AZ (US); Chad Hoyt, Roseville, MN (US); Jad Salman, Wayzata, MN (US); Connor Fredrick, Maple Grove, MN (US)

(73) Assignee: Honeywell International Inc., Charlotte, NC (US)

(21) Appl. No.: 19/267,961

(22) Filed: Jul. 14, 2025

Related U.S. Application Data
(60) Provisional application No. 63/743,833, filed on Jan. 10, 2025.

(51) Int. Cl. G02B 6/42

(52) U.S. Cl. CPC G02B 6/4215; G02B 6/4206

(57) ABSTRACT

A supercontinuum generator includes at least one dispersion compensated transmission line. Each dispersion compensated transmission line includes a pair of a first portion of and a second portion of transmission line optical waveguide that are optically connected by one pair of chirped Bragg gratings. Each chirped Bragg grating includes an optical waveguide with gratings. By interspersing the pair of chirped Bragg gratings between the pair of the first and the second portions, coherence of the spectral components of an optical frequency comb is increased. As a result, a power spectral density, of each of the spectral components of an output optical frequency comb, is increased.

### CROSS-REFERENCE TO RELATED APPLICATIONS

The present application claims benefit of U.S. Patent Application Serial No. 63/743,833 filed Jan. 10, 2025; the entire contents of the aforementioned patent application are incorporated herein by reference as if set forth in its entirety.

### BACKGROUND

A supercontinuum generator increases spectral bandwidth of an input optical frequency comb by four wave mixing. The supercontinuum generator produces an output optical frequency comb with a same spectral line width spacing but with more spectral lines.

Typically, long optical waveguides with relatively low dispersion are used to perform such four wave mixing. To reduce its size, a supercontinuum generator can be formed in an integrated circuit using planar optical waveguides.

To diminish dispersion, such planar optical waveguides must be made thicker. The thicker planar optical waveguide reduces a coupling factor for edge coupling used to inject the input optical frequency comb, and increases propagation loss of the planar optical waveguide. As a result, an input optical frequency comb with higher power must be received by the supercontinuum generator.

### SUMMARY

In some aspects, the techniques described herein relate to a supercontinuum generator including: at least one dispersion compensated transmission line, wherein each dispersion compensated transmission line includes a pair of a first portion of and a second portion of transmission line optical waveguide that are optically connected by one pair of chirped Bragg gratings; an input port that is a port of one of the at least one dispersion compensated transmission line; and an output port that is another port of the one of the at least one dispersion compensated transmission line or a port of another of the at least one dispersion compensated transmission line; wherein each pair of chirped Bragg grating includes a first chirped Bragg grating including a first optical port and a second chirped Bragg grating including a second optical port, and wherein the first portion is connected to the first optical port and the second portion is connected to the second optical port.

In some aspects, the techniques described herein relate to a method of increasing spectral bandwidth of an input optical frequency comb, the method including: receiving the input optical frequency comb at an input port of a supercontinuum generator, wherein the supercontinuum generator includes: at least one dispersion compensated transmission line, wherein each dispersion compensated transmission line includes a pair of a first portion of and a second portion of transmission line optical waveguide that are optically connected by one pair of chirped Bragg gratings; the input port that is a port of one of the at least one dispersion compensated transmission line; an output port that is another port of the one of the at least one dispersion compensated transmission line or a port of another of the at least one dispersion compensated transmission line; wherein each pair of chirped Bragg grating includes a first chirped Bragg grating including a first optical port and a second chirped Bragg grating including a second optical port, and wherein the first portion is connected to the first optical port and the second portion is connected to the second optical port; generating, in the supercontinuum generator, an output optical frequency comb; and emitting, from the output port, the output optical frequency comb, wherein the output optical frequency comb and the input optical frequency comb have a same spectral line width spacing, and wherein the output optical frequency comb has more spectral lines than the input optical frequency comb.

In some aspects, the techniques described herein relate to a supercontinuum generator including: two or more portions of optical waveguide on a substrate; wherein each of two adjacent portions of optical waveguide are optically coupled by a pair of chirped Bragg gratings including two optical waveguides each of which includes gratings.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 illustrates a plan view of one embodiment of a supercontinuum generator utilizing pairs of chirped Bragg gratings.

FIG. 2 illustrates a diagram of a cross-section of one embodiment of planar optical waveguide which may be used in embodiments of the invention.

FIG. 3 illustrates a plan view of one embodiment of a pair of chirped Bragg gratings in which Bragg gratings are implemented by varying a width between core sidewalls.

FIG. 4 illustrates a cross-sectional diagram of one embodiment of a chirped Bragg grating which can be used to implement a pair of Bragg gratings according to embodiments of the invention.

FIG. 5 illustrates a flow diagram of one embodiment of a method of increasing spectral bandwidth of an input optical frequency comb according to embodiments of the invention.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that structural, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments of the invention are a supercontinuum generator formed with optical waveguide, including planar optical waveguide or optical fiber. For pedagogical purposes, the optical wave guide will be illustrated herein as planar optical waveguide. Thus, supercontinuum generator is illustrated herein as being implemented with planar optical waveguide, e.g., on an integrated circuit, and includes one or more pairs of chirped Bragg gratings each of which optically couples two, e.g., adjacent, portions of a planar optical waveguide.

A chirped Bragg grating means a type of Bragg grating, e.g., in planar optical waveguide, where the grating period changes, e.g., linearly, along an axis of optical signal propagation through the chirped Bragg grating; as a result, the chirped Bragg grating has a non-uniform reflection spectrum. The variation in period causes different wavelengths of light to be reflected at different points along the grating. Thus, a broader range of wavelengths, compared to a typical Bragg grating, are reflected by the chirped Bragg grating. This results in a delay that can be used for chromatic dispersion compensation caused by a length of proceeding portion(s) of the planar optical waveguide. Reduced dispersion in the supercontinuum generator causes a reduction in phase difference between different spectral components of the optical frequency comb in the supercontinuum generator. By increasing the coherence of such spectral components, a power spectral density, of each of the spectral components of an output optical frequency comb, is increased.

As a result, the planar optical waveguide need not be as thick as with prior art supercontinuum generators. Further, the input optical frequency comb requires lower power.

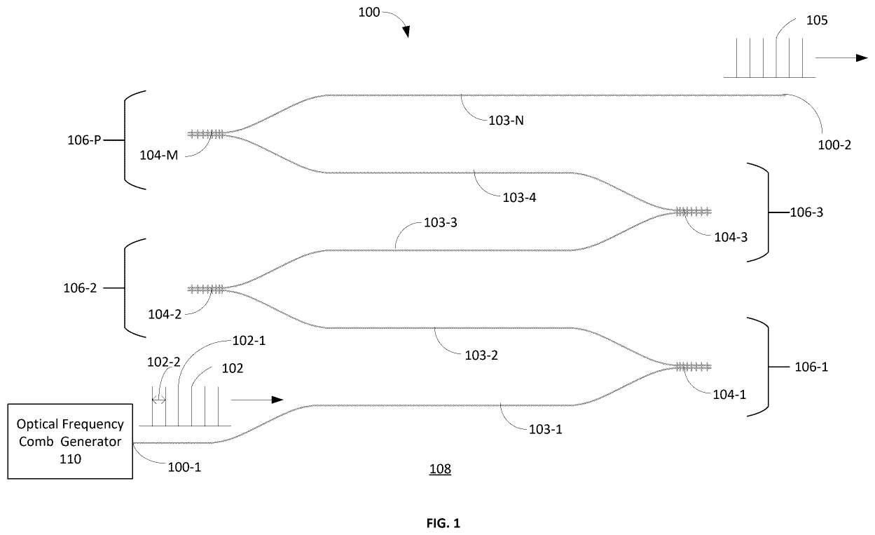

FIG. 1 illustrates a plan view of one embodiment of a supercontinuum generator 100 utilizing pairs of chirped Bragg gratings. The supercontinuum generator 100 includes an input port 100-1 at a first end of a first portion 103-1 of planar optical waveguide, and an output port 100-2 at a second end of an Nth portion of planar optical waveguide. The supercontinuum generator 100 further includes N portions 103-1, 103-2, 103-3, 103-4, 103-N of planar optical waveguide. N is an integer greater than 1. Optionally, N portions 103-1, 103-2, 103-3, 103-4, 103-N of planar optical waveguide are of equal length. Each such portion of planar optical waveguide may be referred to as a waveguide portion, e.g., a first waveguide portion 103-1, a second waveguide portion 103-2, a third waveguide portion 103-3, and an Nth waveguide portion 103-N.

In the illustrated embodiment, each of the N portions 103-1, 103-2, 103-3, 103-4, 103-N of the planar optical waveguide is optically coupled to another of the other N portions 103-1, 103-2, 103-3, 103-4, 103-N of the planar optical waveguide by a pair of chirped Bragg gratings 104-1, 104-2, 104-3, 104-M. M is equal to N minus one. In the illustrated embodiment, the number of pairs of chirped Bragg gratings 104-1, 104-2, 104-3, 104-M is one less than the number of portions 103-1, 103-2, 103-3, 103-4, 103-N of the planar optical waveguide.

An end of one of the N portions 103-1, 103-2, 103-3, 103-4, 103-N of the planar optical waveguide is optically coupled to an end of a first planar optical waveguide of the pair of chirped Bragg grating. An end of the other one of the N portions 103-1, 103-2, 103-3, 103-4, 103-N of the planar optical waveguide is optically coupled to an end of a second planar optical waveguide of the pair chirped Bragg grating 104-1, 104-2, 104-3, 104-M. As is illustrated elsewhere herein, a first chirped Bragg grating of the pair has a surface, e.g., a sidewall, or a portion thereof which is adjacent to a surface, e.g., a sidewall, or a portion thereof, of the second chirped Bragg grating of the pair; this facilitates optically coupling between the first and the second chirped Bragg gratings.

Optionally, the aforementioned one and other portions are adjacent to one another. Optionally, the aforementioned optically coupled ends of the one and the other portions are also adjacent to one another. When the N portions 103-1, 103-2, 103-3, 103-4, 103-N of planar optical waveguide are of equal length, the chirped Bragg gratings periodically spaced between the input port 100-1 and the output port 100-2 of the supercontinuum generator 100. Each pair of chirped Bragg gratings diminishes the dispersion in the pulsed optical signal caused by the portion(s) of planar optical waveguide preceding the pair of chirped Bragg gratings.

The supercontinuum generator 100 includes at least one, e.g., at least two, dispersion compensated planar optical transmission line. A dispersion compensated planar optical transmission line 106-1, 106-2, 106-3, 106-P includes a pair of, e.g., adjacent, portions (103-1, 103-2), (103-2, 103-3), (103-3, 103-4), (103-4, 103-N) of the planar optical waveguide that are optically connected through one pair of chirped Bragg gratings 104-1, 104-2, 104-3, 104-M; the two portions of the pair may be referred to as the first pair portion and the second pair portion. There are P dispersion compensated planar optical transmission lines, where P is greater than zero. Each dispersion compensated planar optical transmission line has a first port and a second port. The input port 100-1 is a port of one of the at least one dispersion compensated transmission line. The output port 100-2 is another port of the one of the at least one dispersion compensated transmission line or a port of another of the at least one dispersion compensated transmission line.

The input port 100-1 of the supercontinuum generator 100 is configured to be optically coupled to an optical frequency comb generator 110. The optical frequency comb generator 110 is configured to generate an input optical frequency comb 102. Four wave mixing in each of the N portions 103-1, 103-2, 103-3, 103-4, 103-N of the planar optical waveguide generates an output optical frequency comb 105 with a same spectral line width spacing as, but with more spectral lines than, the input optical frequency comb 102. Thus, the spectral bandwidth of the output optical frequency comb 105 is larger than the spectral bandwidth of the input optical frequency comb 102.

Each of the input optical frequency comb 102 and the output optical frequency comb 105 include spectral lines 102-1. Adjacent spectral lines, in each of the input optical frequency comb 102 and the output optical frequency comb 105, are separated by a spectral line width spacing 102-2.

Each portion of planar optical waveguide and each chirped Bragg grating is implemented with planar optical waveguide including a core surrounded by cladding. The core has a higher index of refraction than the cladding. Optionally, the core includes silicon dioxide and the cladding includes silicon nitride. Such planar optical waveguide is formed on a substrate 108.

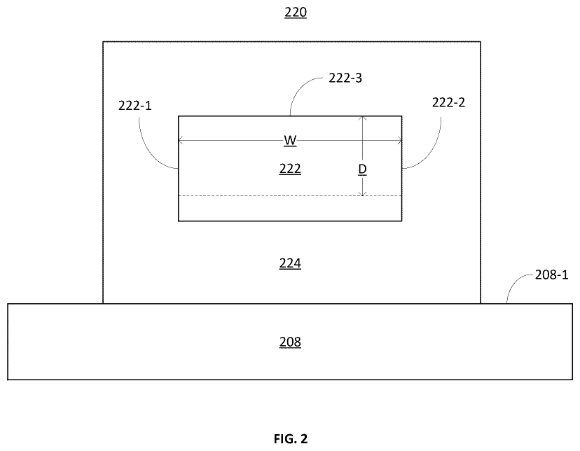

FIG. 2 illustrates a diagram of a cross-section of one embodiment of planar optical waveguide 220 which may be used in embodiments of the invention. Such planar optical waveguide 220 may be used to implement planar optical waveguide and/or chirped Bragg gratings. The core 222 is surrounded by the cladding 224. The core 222 and the cladding 224 are over the substrate 208. Optionally, the cladding 224 is on the substrate 208.

The cladding 224 and the core 222 are over a substrate surface 208-1 of the substrate 208. The core 222 has a first core sidewall 222-1, a second core sidewall 222-2, and a top core surface 222-3. The first and the second core sidewalls 222-1, 222-2 are parallel to one another and substantially orthogonal to the substrate surface 208-1. The top core surface 222-3 is separated, at least, by the core 222 and a portion of the cladding 224 from the substrate surface 208-1, and is substantially parallel to the substrate surface 208-1.

Each pair of Bragg gratings includes a first chirped Bragg grating and a second chirped Bragg grating. The first chirped Bragg grating (cBg) includes a first chirped Bragg grating optical waveguide including a first set of chirped Bragg grating elements, a cBg input port, and a first cBg port opposite the cBg input port. The cBg input port is configured to be optically connected to one portion of the pair of portions of planar optical waveguide. Optionally, the first cBg port is configured not to be terminated, e.g., to be terminated into free space.

The second chirped Bragg grating includes a second chirped Bragg grating optical waveguide including a second set of Bragg grating elements, a cBg output port, and a second cBg port opposite the cBg output port. The cBg output port is configured to be optically connected to another portion of planar optical waveguide. Optionally, the second cBg port is configured not to be terminated, e.g., to be terminated into free space.

An optical signal is configured to flow, from the portion of planar optical waveguide, through the cBg input port towards the first cBg port. The optical signal is optically coupled from the first chirped Bragg grating to the second chirped Bragg grating and flows towards the cBg output port.

Each Bragg grating includes planar optical waveguide whose core dimensions are varied. Variation of core dimensions may be accomplished in different ways that vary core dimension along an axis perpendicular to a direction of propagation of an optical signal in the planar optical waveguide. For example, the core dimensions can be varied by varying a width W between the first and the second core sidewalls or by varying a recess depth D starting from the top core surface. Optionally, the planar optical waveguides in which chirped Bragg gratings are formed, of the pair, have adjacent sidewalls which are substantially parallel.

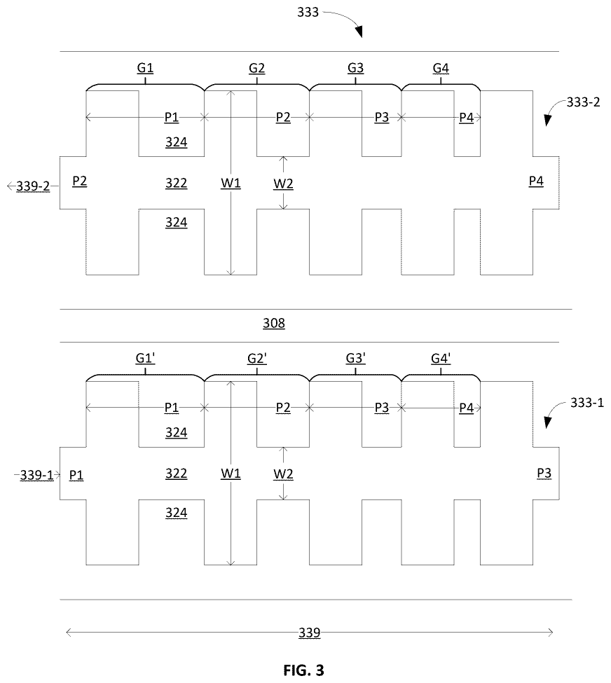

FIG. 3 illustrates a plan view of one embodiment of a pair 333 of chirped Bragg gratings in which Bragg gratings are implemented by varying a width between core sidewalls. The substrate 308, the core 322, and the cladding 324 are each shown in FIG. 3.

A first chirped Bragg grating 333-1 has a cBg input port P1 and a first cBg port P2. The input cBg port P1 is configured to be optically connected to a first portion of a pair of portions of planar optical waveguide. Optionally, the first cBg port P2 is configured to be terminated into free space. The second chirped Bragg grating 333-2 has an output cBg port P2 and a second cBg port P4. The output cBg port P2 is configured to be optically connected to a second portion of a pair of portions of planar optical waveguide. Optionally, the second cBg port P4 is configured to be terminated into free space.

A first optical signal 339-1 is configured to be received at the input port P1 and propagate along an axis 339 through the first chirped Bragg grating 333-1. A second optical signal 339-2, which is a portion of all or some of the first optical signal 339-1 optically coupled into the second chirped Bragg grating 333-2, propagates along the axis 339 through the second chirped Bragg grating 333-2 in a direction that is opposite the direction of propagation of the first optical signal 339-1. The axis 339 is parallel to segments formed by each of (a) the input cBg port P1 and the first cBg port P3 and (b) the output cBg port P2 and the second cBg port P4.

Optionally, the width between the first and the second core sidewalls alternatively varies between a first width W1 and a second width W2. The second width W2 is less than the first width W2.

The first chirped Bragg grating 333-1 includes a first planar optical waveguide including a first set of grating elements G1, G2, G3, G4. The second chirped Bragg grating 333-2 includes a second planar optical waveguide including a second set of grating elements G1′, G2′, G3′, G4′. A grating period P1, P2, P3, P4 of the grating elements of the chirped Bragg gratings 333-1, 333-2 changes, e.g., diminishes or increases, along the axis 339. Optionally, the grating period decreases in a direction of optical signal propagation in one chirped Bragg grating configured to receive the first optical signal 339-1, and the grating period increases in a direction of optical signal propagation in the other chirped Bragg grating configured to emit the second optical signal 339-2. Optionally, as illustrated in FIG. 3, the grating periods P1, P2, P3, P4 for adjacent grating elements of the first and the second chirped Bragg gratings 333-1, 333-2 are substantially the same; thus, the first grating period P1 of each first grating element G1, G1′, the second grating period P2 of each second grating element G2, G2′, the third grating period P3 of each third grating element G3, G3′, and the fourth grating period P4 of each grating element G4, G4′ are the same.

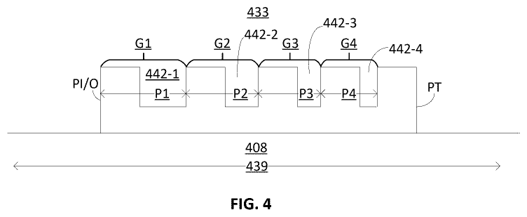

FIG. 4 illustrates a cross-sectional diagram of one embodiment of a chirped Bragg grating 433 which can be used to implement a pair of Bragg gratings according to embodiments of the invention. The substrate 408 is shown in FIG. 3.

In FIG. 4, each grating element G1, G2, G3, G4 includes a recess 442-1, 442-2, 442-3, 442-4 through cladding above the top core surface and through a portion of the core including the top core surface. A grating period P1, P2, P3, P4 of the grating elements G1, G2, G3, G4 of the chirped Bragg grating 433 changes, e.g., diminishes or increases, along the axis 439. Each of the first and the second chirped Bragg gratings of a pair of chirped Bragg gratings may be so implemented.

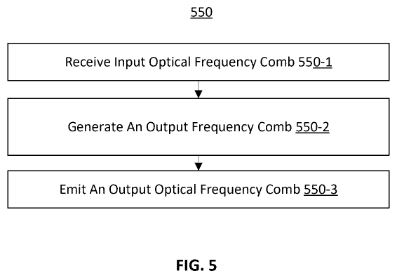

FIG. 5 illustrates a flow diagram of one embodiment of a method 550 of increasing spectral bandwidth of an input optical frequency comb according to embodiments of the invention. Optionally, the method 550 may be implemented utilizing one or more the apparatuses illustrated in FIGS. 1-4. To the extent that the methods shown in any Figures are described herein as being implemented with any of the systems illustrated herein, it is to be understood that other embodiments can be implemented in other ways.

The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 550-1, an input optical frequency comb is received, e.g., at an input port of the supercontinuum generator including at least one dispersion compensated planar optical transmission line. In block 550-2, an output frequency comb is generated by the super continuum generator. As discussed elsewhere herein, four wave mixing in each of the portions of the planar optical waveguide, that comprise the at least one dispersion compensated planar optical transmission line, generates the output optical frequency comb with a same spectral line width spacing as, but with more spectral lines than, the input optical frequency comb. In block 550-3, an output optical frequency comb is emitted, e.g., an output port of the supercontinuum generator.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and/or the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected.

Terms of relative position as used in this application are defined based on a plane parallel to the conventional plane or working surface of a material (e.g., a layer or a substrate), regardless of orientation. Terms such as “on,” “higher,” “lower,” “over,” “top,” and “under” are defined with respect to the conventional plane or working surface being on the top surface of a layer or substrate, regardless of orientation. The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

### Exemplary Embodiments

Example 1 includes a supercontinuum generator comprising: at least one dispersion compensated transmission line, wherein each dispersion compensated transmission line includes a pair of a first portion of and a second portion of transmission line optical waveguide that are optically connected by one pair of chirped Bragg gratings; an input port that is a port of one of the at least one dispersion compensated transmission line; and an output port that is another port of the one of the at least one dispersion compensated transmission line or a port of another of the at least one dispersion compensated transmission line; wherein each pair of chirped Bragg grating includes a first chirped Bragg grating including a first optical port and a second chirped Bragg grating including a second optical port, and wherein the first portion is connected to the first optical port and the second portion is connected to the second optical port.
Example 2 includes the supercontinuum generator of Example 1, wherein the transmission line optical waveguide and each chirped Bragg grating includes planar optical waveguide on a substrate.
Example 3 includes the supercontinuum generator of any of Examples 1-2, wherein each chirped Bragg grating includes optical waveguide including at least one sidewall with gratings.
Example 4 includes the supercontinuum generator of any of Examples 1-3, wherein a grating period of the chirped Bragg grating changes linearly along an axis of optical signal propagation through the chirped Bragg grating.
Example 5 includes the supercontinuum generator of any of Examples 1-4, further comprising an optical frequency comb generator optically connected to the input port and configured to emit an input optical frequency comb.
Example 6 includes the supercontinuum generator of any of Examples 1-5, wherein the at least one dispersion compensated transmission line comprises at least two dispersion compensated transmission lines.
Example 7 includes the supercontinuum generator of any of Examples 1-6, wherein the first portion of transmission line optical waveguide and the second portion of transmission line optical waveguide have equal lengths.
Example 8 includes a method of increasing spectral bandwidth of an input optical frequency comb, the method comprising: receiving the input optical frequency comb at an input port of a supercontinuum generator, wherein the supercontinuum generator comprises: at least one dispersion compensated transmission line, wherein each dispersion compensated transmission line includes a pair of a first portion of and a second portion of transmission line optical waveguide that are optically connected by one pair of chirped Bragg gratings; the input port that is a port of one of the at least one dispersion compensated transmission line; an output port that is another port of the one of the at least one dispersion compensated transmission line or a port of another of the at least one dispersion compensated transmission line; wherein each pair of chirped Bragg grating includes a first chirped Bragg grating including a first optical port and a second chirped Bragg grating including a second optical port, and wherein the first portion is connected to the first optical port and the second portion is connected to the second optical port; generating, in the supercontinuum generator, an output optical frequency comb; and emitting, from the output port, the output optical frequency comb, wherein the output optical frequency comb and the input optical frequency comb have a same spectral line width spacing, and wherein the output optical frequency comb has more spectral lines than the input optical frequency comb.
Example 9 includes the method of Example 8, wherein the transmission line optical waveguide and each chirped Bragg grating each include planar optical waveguide on a substrate.
Example 10 includes the method of any of Examples 8-9, wherein each chirped Bragg grating includes optical waveguide including at least one sidewall with gratings.
Example 11 includes the method of any of Examples 8-10, wherein a grating period of the chirped Bragg grating changes linearly along an axis of optical signal propagation through the chirped Bragg grating.
Example 12 includes the method of any of Examples 8-11, wherein the input optical frequency comb is emitted from an optical frequency comb generator.
Example 13 includes the method of any of Examples 8-12, wherein the at least one dispersion compensated transmission line comprises at least two dispersion compensated transmission lines.
Example 14 includes the method of any of Examples 8-13, wherein the first portion of transmission line optical waveguide and the second portion of transmission line optical waveguide have equal lengths.
Example 15 includes a supercontinuum generator comprising: two or more portions of optical waveguide on a substrate; wherein each of two adjacent portions of optical waveguide are optically coupled by a pair of chirped Bragg gratings including two optical waveguides each of which includes gratings.
Example 16 includes the supercontinuum generator of Example 15, wherein the optical waveguide of the two or more portions is planar optical waveguide on a substrate, wherein the optical waveguide of each of the two adjacent portions is planar optical waveguide on the substrate, and wherein each of the two optical waveguides is other planar optical waveguide on the substrate.
Example 17 includes the supercontinuum generator of any of Examples 15-16, wherein each of the two optical waveguides, of the pair of chirped Bragg gratings, includes sidewalls orthogonal to a surface of the substrate and including the gratings.

Example 18 includes the supercontinuum generator of any of Examples 15-17, wherein a grating period of each chirped Bragg grating changes linearly along an axis of optical signal propagation through a chirped Bragg grating.

Example 19 includes the supercontinuum generator of any of Examples 15-18, further comprising an optical frequency comb generator optically connected to an input port of the supercontinuum generator and configured to emit an input optical frequency comb.

Example 20 includes the supercontinuum generator of any of Examples 15-19, wherein each of the two or more portions of planar optical waveguide has a same length.

What is claimed is:

1. A supercontinuum generator comprising:
at least one dispersion compensated transmission line, wherein each dispersion compensated transmission line includes a pair of a first portion of and a second portion of transmission line optical waveguide that are optically connected by one pair of chirped Bragg gratings;
an input port that is a port of one of the at least one dispersion compensated transmission line; and
an output port that is another port of the one of the at least one dispersion compensated transmission line or a port of another of the at least one dispersion compensated transmission line;
wherein each pair of chirped Bragg grating includes a first chirped Bragg grating including a first optical port and a second chirped Bragg grating including a second optical port, and wherein the first portion is connected to the first optical port and the second portion is connected to the second optical port.

2. The supercontinuum generator of claim 1, wherein the transmission line optical waveguide and each chirped Bragg grating includes planar optical waveguide on a substrate.

3. The supercontinuum generator of claim 1, wherein each chirped Bragg grating includes optical waveguide including at least one sidewall with gratings.

4. The supercontinuum generator of claim 1, wherein a grating period of the chirped Bragg grating changes linearly along an axis of optical signal propagation through the chirped Bragg grating.

5. The supercontinuum generator of claim 1, further comprising an optical frequency comb generator optically connected to the input port and configured to emit an input optical frequency comb.

6. The supercontinuum generator of claim 1, wherein the at least one dispersion compensated transmission line comprises at least two dispersion compensated transmission lines.

7. The supercontinuum generator of claim 1, wherein the first portion of transmission line optical waveguide and the second portion of transmission line optical waveguide have equal lengths.

8. A method of increasing spectral bandwidth of an input optical frequency comb, the method comprising:
receiving the input optical frequency comb at an input port of a supercontinuum generator, wherein the supercontinuum generator comprises:
at least one dispersion compensated transmission line, wherein each dispersion compensated transmission line includes a pair of a first portion of and a second portion of transmission line optical waveguide that are optically connected by one pair of chirped Bragg gratings;
the input port that is a port of one of the at least one dispersion compensated transmission line;
an output port that is another port of the one of the at least one dispersion compensated transmission line or a port of another of the at least one dispersion compensated transmission line;
wherein each pair of chirped Bragg grating includes a first chirped Bragg grating including a first optical port and a second chirped Bragg grating including a second optical port, and wherein the first portion is connected to the first optical port and the second portion is connected to the second optical port;
generating, in the supercontinuum generator, an output optical frequency comb; and
emitting, from the output port, the output optical frequency comb, wherein the output optical frequency comb and the input optical frequency comb have a same spectral line width spacing, and wherein the output optical frequency comb has more spectral lines than the input optical frequency comb.

9. The method of claim 8, wherein the transmission line optical waveguide and each chirped Bragg grating each include planar optical waveguide on a substrate.

10. The method of claim 8, wherein each chirped Bragg grating includes optical waveguide including at least one sidewall with gratings.

11. The method of claim 8, wherein a grating period of the chirped Bragg grating changes linearly along an axis of optical signal propagation through the chirped Bragg grating.

12. The method of claim 8, wherein the input optical frequency comb is emitted from an optical frequency comb generator.

13. The method of claim 8, wherein the at least one dispersion compensated transmission line comprises at least two dispersion compensated transmission lines.

14. The method of claim 8, wherein the first portion of transmission line optical waveguide and the second portion of transmission line optical waveguide have equal lengths.

15. A supercontinuum generator comprising:
two or more portions of optical waveguide on a substrate;
wherein each of two adjacent portions of optical waveguide are optically coupled by a pair of chirped Bragg gratings including two optical waveguides each of which includes gratings.

16. The supercontinuum generator of claim 15, wherein the optical waveguide of the two or more portions is planar optical waveguide on a substrate, wherein the optical waveguide of each of the two adjacent portions is planar optical waveguide on the substrate, and wherein each of the two optical waveguides is other planar optical waveguide on the substrate.

17. The supercontinuum generator of claim 15, wherein each of the two optical waveguides, of the pair of chirped Bragg gratings, includes sidewalls orthogonal to a surface of the substrate and including the gratings.

18. The supercontinuum generator of claim 15, wherein a grating period of each chirped Bragg grating changes linearly along an axis of optical signal propagation through a chirped Bragg grating.

19. The supercontinuum generator of claim 15, further comprising an optical frequency comb generator optically connected to an input port of the supercontinuum generator and configured to emit an input optical frequency comb.

20. The supercontinuum generator of claim 15, wherein each of the two or more portions of planar optical waveguide has a same length.
